(19) United States
(12) Patent Application Publication
(10) Pub. No.: US 2024/0184124 A1
(43) Pub. Date: Jun. 6, 2024

(54) SPATIAL POLARIZATION DISPLAY FOR VARIFOCAL SYSTEM

(71) Applicant: Meta Platforms Technologies, LLC, Menlo Park, CA (US)

(72) Inventors: Ali Altaqui, Raleigh, NC (US); Xuan Wang, Kirkland, WA (US); Lu Lu, Kirkland, WA (US); Michael Escuti, Redmond, WA (US); Chulwoo Oh, Sammamish, WA (US); Hsien-Hui Cheng, Woodinville, WA (US); Jihwan Kim, Cary, NC (US); Yuge Huang, Painted Post, NY (US); Yun-Han Lee, Redmond, WA (US); Brian Wheelwright, Sammamish, WA (US)

(21) Appl. No.: 18/237,332

(22) Filed: Aug. 23, 2023

Related U.S. Application Data
(60) Provisional application No. 63/430,774, filed on Dec. 7, 2022.
(60) Provisional application No. 63/429,779, filed on Dec. 2, 2022.

(51) Int. Cl. G02B 27/01; G02B 5/30; G02B 27/09; G02F 1/01

(52) U.S. Cl. CPC G02B 27/0179; G02B 5/3083; G02B 27/0172; G02B 27/0922; G02B 27/0955; G02F 1/0136; G02B 2027/0185

(57) ABSTRACT

A multi-focal system includes a display pixel array, a pixelated polarization array, and a Pancharatnam-Berry phase (PBP) lens. The display pixel array includes a first display pixels generating first display light and a second display pixels generating second display light. The pixelated polarization array has first pixels and second pixels. The first pixels are aligned with the first display pixels to generate a first polarized light having a first polarization orientation. The second pixels are aligned with the second display pixels to generate a second polarized light having a second polarization orientation different from the first polarization orientation. The PBP lens is configured to focus the first polarized light having the first polarization orientation to a first focal length and focus the second polarized light having the second polarization orientation to a second focal length that is greater than the first focal length.

### CROSS-REFERENCE TO RELATED APPLICATIONS

This application claims priority to U.S. Provisional Application No. 63/430,774 filed Dec. 7, 2022 and U.S. Provisional Application No. 63/429,779 filed Dec. 2, 2022, which are hereby incorporated by reference.

### TECHNICAL FIELD

This disclosure relates generally to optics, and in particular to lenses.

### BACKGROUND INFORMATION

Systems with different focal points are useful in both imaging and display applications. Generally, different focal points are accomplished with adjusting refractive lenses with respect to one another.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a system with an unpolarized display pixel array (micro-OLED) having Red-Green-Blue (RGB) display pixels, in accordance with aspects of the disclosure.

FIG. 2 illustrates the example polarization state output from an example combination of a display, pixelated polarization array, and a QWP and the right side illustrates that the PBP lens has two focal planes depending on the polarization orientation of the incident light, in accordance with aspects of the disclosure.

FIG. 3 illustrates a side view of the system where the pixels from the pixelated polarization array are aligned with (and disposed over) the display pixels of the display pixel array in a one-to-one correspondence, in accordance with aspects of the disclosure.

FIGS. 4A and 4B illustrate another implantation of the disclosure capable of providing four focal lengths, in accordance with aspects of the disclosure.

FIG. 5 illustrates a multi-focal system including a display pixel array, a linear polarizer, a pixelated micro-retarder array, and a PBP lens, in accordance with aspects of the disclosure.

FIG. 6 illustrates an additional view of the multi-focal system of FIG. 5, in accordance with aspects of the disclosure.

FIG. 7 illustrates that the linear polarizer of FIGS. 5 and 6 may be removed for a multi-focal system that has polarized display light generated by the display pixel array, in accordance with aspects of the disclosure.

FIG. 8 illustrates that a switchable half waveplate and a second PBP lens can be added to the multi-focal system to provide four focal lengths, in accordance with aspects of the disclosure.

FIG. 9 illustrates a multi-focal system that includes a display pixel array, a pixelated switchable waveplate, and a PBP lens, in accordance with aspects of the disclosure.

FIG. 10 illustrates a first fringe pattern 111, a second fringe pattern 112, and a third fringe pattern 113. Sparser or lower bit stripes (e.g. first fringe pattern 111) are applied onto the target to prevent ambiguity while denser or higher bit stripes (e.g. third fringe pattern 113) are applied to the target to achieve higher resolution, in accordance with aspects of the disclosure.

FIG. 11 illustrates a pulse width modulation (PWM) based iTOF illumination is utilized for fringe pattern projection, in accordance with aspects of the disclosure.

FIG. 12 illustrates that fringe pattern 1230 of FIG. 11 can be expanded to a 2D fringe pattern 1230 that includes a first spatial frequency and a second spatial frequency, in accordance with aspects of the disclosure.

FIG. 13 illustrates an eye tracking system where projector patterns include vortex array with one or more image sensor to capture the intensity distribution, including an image sensor camera, in accordance with aspects of the disclosure.

FIG. 14 illustrates an embodiment of a projector with light source and a phase mask with a light source control block to modulate the coherence of light, in accordance with aspects of the disclosure.

FIG. 15 illustrates an embodiment of a projector with a light source, and phase mask, including a light source control block with an image processing and system control device, in accordance with aspects of the disclosure.

FIG. 16 illustrates an embodiment of the projector including a light source and an active phase control element such as a Spatial light modulator (in transmission), deformable mirror (in reflection), in accordance with aspects of the disclosure.

FIG. 17 illustrates a head mounted device including a reflective phase mask and light source, in accordance with aspects of the disclosure.

FIG. 18 illustrates a laser and SPAD camera onto Galvo mirror(s) reflecting off of the display lens into the eye, in accordance with the aspects of the disclosure.

### DETAILED DESCRIPTION

Embodiments of systems and methods of sensing structured light with time of flight (TOF) with duty cycle modulation are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

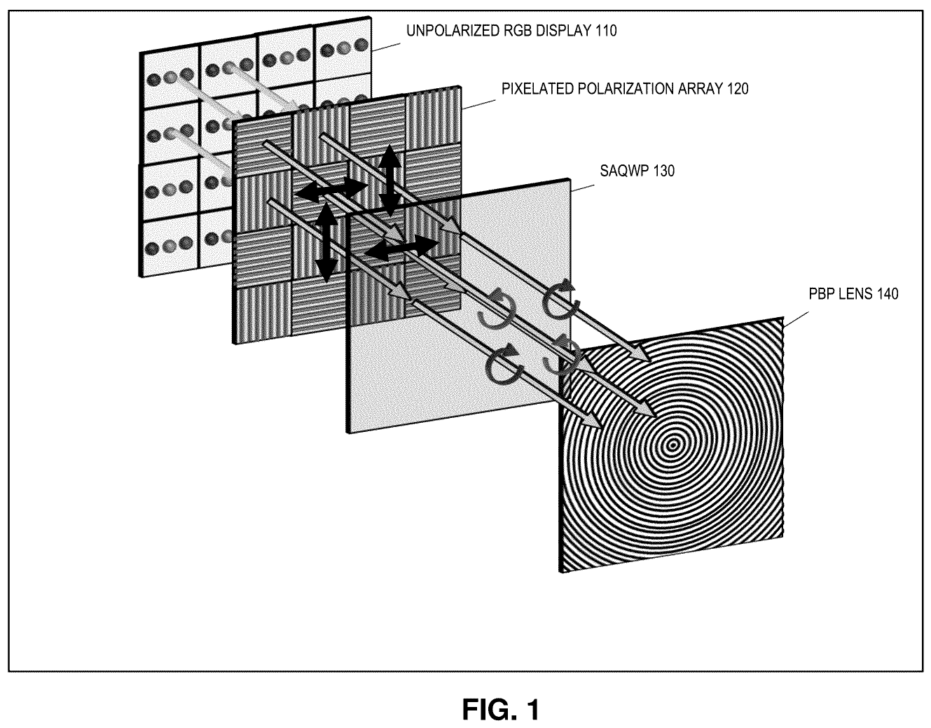

In the context of head mounted displays, it may be advantageous to have an optical system with more than one focal length. This disclosure includes various implementations of a multi-focal optical system. The disclosed multi-focal optical systems combine spatial polarization of display light to illuminate a Pancharatnam-Berry Phase (PBP) lens. When the display light has a first polarization orientation, the PBP lens focuses the display light at a first focal length. And, when the display light has a second polarization (different from the first polarization orientation), the PBP lens focuses the display light at a second focal length that is different than the first focal length. In some implementations, the multi-focal system can provide four different focal lengths for display light. These and other embodiments are described in more detail in connections with FIGS. 1-9.

FIG. 1 illustrates a system with an unpolarized display pixel array (micro-OLED) having Red-Green-Blue (RGB) display pixels 110 emitting display light. Each RGB pixel may have, from left to right, a Red subpixel, a Green subpixel, and a Blue subpixel. The display light illuminates a pixelated polarization array having first pixels and second pixels. The pixel size of the pixels in the pixelated polarization array 120 may be less than 10 microns. In an implementation, the pixel size of the pixels in the pixelated polarization array 120 is less than 5 microns. The first pixels of the pixelated polarization array 120 are aligned with first display pixels to generate a first polarized light having a first polarization orientation and the second pixels of the pixelated polarization array are aligned with second display pixels to generate a second polarized light having a second polarization orientation different from the first polarization orientation. The first polarization orientation is a first linear polarization orientation that is orthogonal to a second linear polarization orientation of the second polarization orientation, in FIG. 1. The first display pixels and the second display pixels are interspersed with each other in a checkerboard pattern of the display pixel array; and the first pixels and second pixels of the pixelated polarization array are also interspersed with each other in a checkerboard pattern to align with the first display pixels and the second display pixels.

The different polarization orientations of the display light propagate to a super achromatic quarter waveplate (SAQWP) 130. The quarter waveplate (QWP) is configured to shift the polarization axis of incident light by π/4. Therefore, incident linearly polarized light may be converted to circularly polarized light by the QWP. The QWP may be made of birefringent materials such as quartz, organic material sheets, or liquid crystal, for example.

The display light propagating toward the PBP lens has right-hand circular polarization (RHCP) if the display light was emitted by the first display pixels (and thus encountered the first pixels of the pixelated polarization array), in the illustrated implementation. The display light propagating toward the PBP lens has left-hand circular polarization (LHCP) if the display light was emitted by the second display pixels (and thus encountered the second pixels of the pixelated polarization array), in the illustrated implementation. Thus, the system can be driven by processing logic (not particularly illustrated) to emit RHCP display light or LHCP by driving the first display pixels or the second display pixels, respectively.

After encountering the SAQWP 130, the display light encounters the PBP lens 140 (also known as a geometric phase lens). The PBP lens 140 is configured to focus the first polarized light having the first polarization orientation to a first focal length and focus the second polarized light having the second polarization orientation to a second focal length.

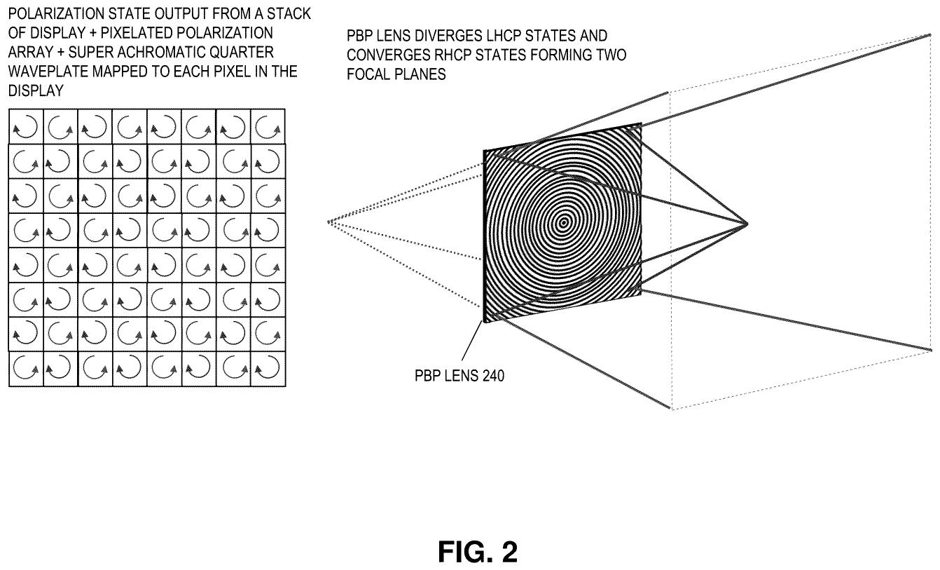

The left portion of FIG. 2 illustrates the example polarization state output from an example combination of a display, pixelated polarization array, and a QWP. The right side of FIG. 2 illustrates that the PBP lens 240 has two focal planes depending on the polarization orientation of the incident light. In the illustrated example, the PBP lens converges RHCP light to a first focal length and diverges LHCP light to a second focal length.

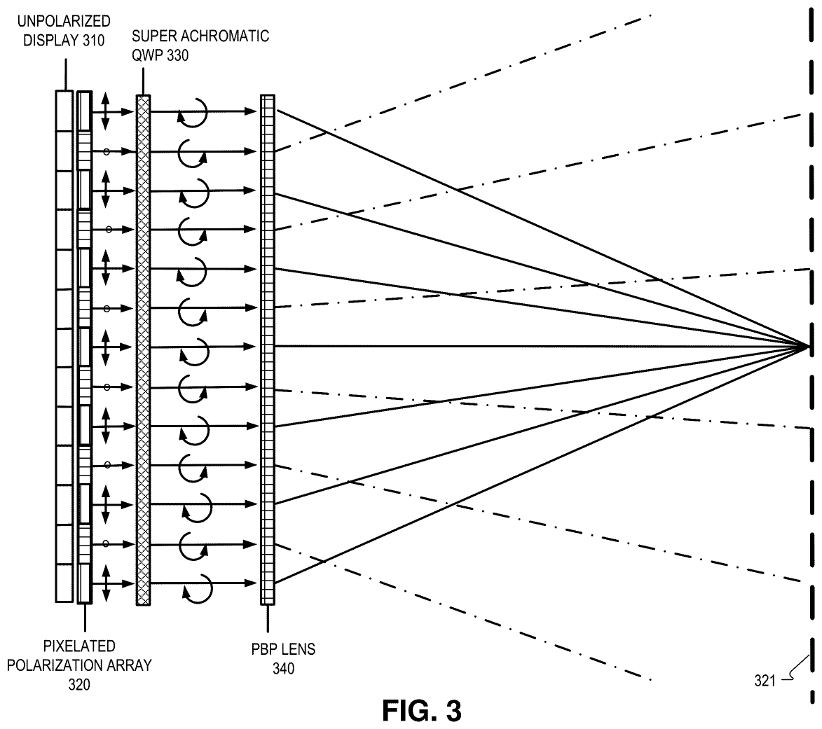

FIG. 3 illustrates a side view of the system where the pixels from the pixelated polarization array are aligned with (and disposed over) the display pixels of the display pixel array in a one-to-one correspondence. The PBP lens 340 focuses the RHCP light to a first focal length 321 and focuses the LHCP light to a second focal length (not particularly illustrated) that is a negative focal length. The negative focal length is less than the first focal length 321 that is a positive focal length.

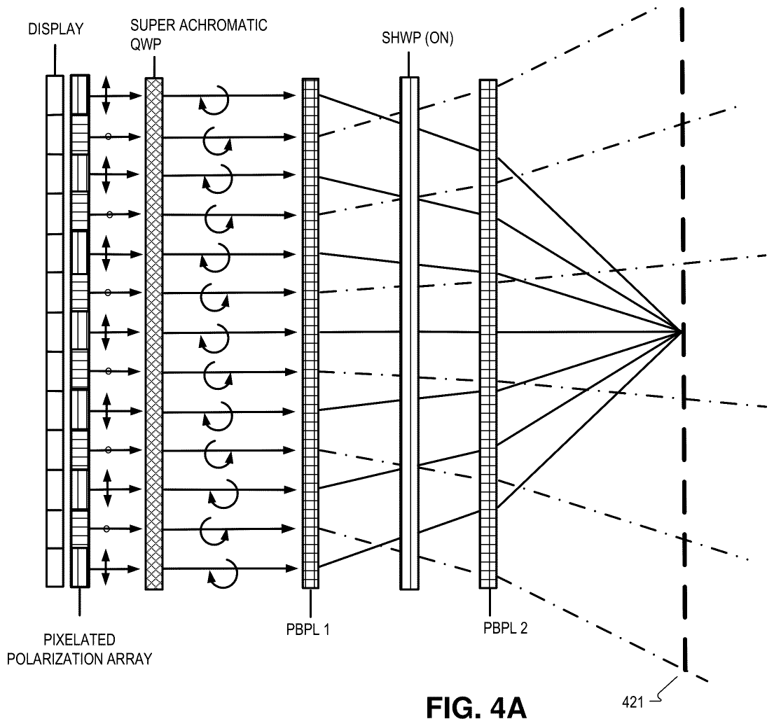

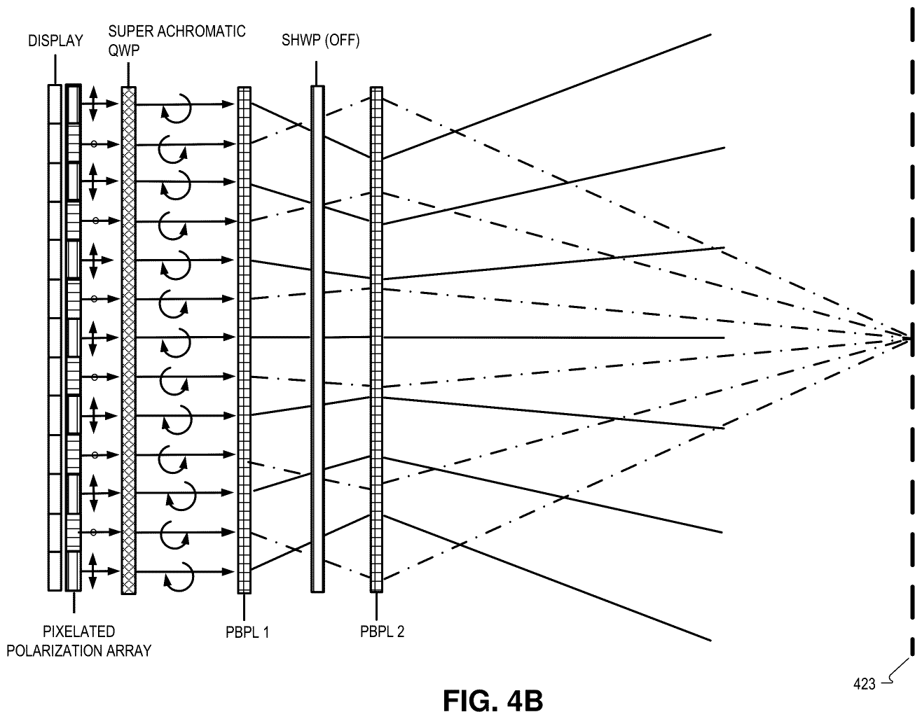

FIGS. 4A-4B illustrate another implantation of the disclosure capable of providing four focal lengths. FIG. 4A illustrates a first state of the system where a switchable waveplate (a switchable half waveplate in the illustrated example) is driven to an ON state to focus the display light to a focal length 421. FIG. 4B illustrates a second state of the system where the switchable waveplate is driven to an ON state to focus the display light to a focal length 423 that is greater than focal length 421.

The multi-focal system of FIGS. 4A and 4B includes a display pixel array, a pixelated polarization array, a first PBP lens, a second PBP lens and a switchable waveplate disposed between the first PBP lens and the second PBP lens. The illustrated implementation includes a QWP disposed between the pixelated polarization array and the first PBP lens.

In operation, processing logic may be configured to (1) drive the multi-focal system to a first focal length (e.g. focal length 421) by driving the first display pixels to generate the first display light (solid lines light in FIG. 4A) while driving the switchable waveplate to a first retardance state (e.g. π/2 or 180 degrees); (2) drive the multi-focal system to a second focal length by driving the first display pixels to generate the first display light (solid lines light in FIG. 4B) while driving the switchable waveplate to a second retardance state (0 degrees); (3) drive the multi-focal system to a third focal length by driving the second display pixels to generate the second display light (dashed lines light in FIG. 4A) while driving the switchable waveplate to a first retardance state; and (4) drive the multi-focal system to a fourth focal length (e.g. focal length 423) by driving the second display pixels to generate the second display light (dashed lines light in FIG. 4B) while driving the switchable waveplate to the second retardance state.

Focal length 423 is greater than focal length 421. The focal length of the second display light (dashed lines light) in FIG. 4A is a negative a focal length since the dashed lines light diverges when it encounters the first PBP and then diverges again in encountering the second PBP. The first display light (solid lines light) in FIG. 4B converges after encountering the first PBP and diverges after encountering the second PBP. Thus, by time-multiplexing the display pixels and driving the retardance state of the switchable waveplate, the system of FIGS. 4A and 4B may provide four different focal lengths.

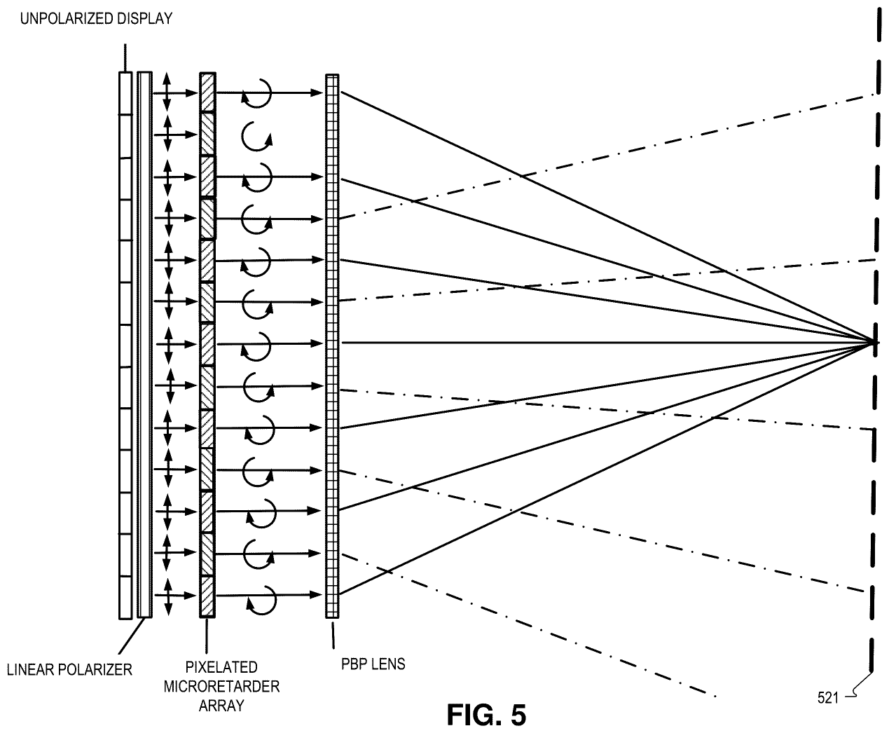

FIG. 5 illustrates a multi-focal system including a display pixel array, a linear polarizer, a pixelated micro-retarder array, and a PBP lens. FIG. 5 shows that a linear polarizer layer may be used to generate homogenous linear polarized light from display light generated by an unpolarized display pixel array. The pixelated retarder array has first retarders and second retarders with the optical axis of the first retarders being orthogonal to the optical axis of the second retarders. The first retarders are aligned with the first display pixels to generate first polarized light having a first polarization orientation (e.g. solid lines having RHCP), and the second pixels aligned with the second display pixels to generate a second polarized light having a second polarization orientation (e.g. dashed lines having LHCP) different from the first polarization orientation. Each pixel in the pixelated micro-retarder is dynamically and individually controllable to switch between retardance states (e.g. π/4 and 0) to generate different orientations of circularly polarized light. In the illustrated implementations, the RHCP light is focused to focal length 521 by PBP lens while LHCP is focused to a different (negative) focal length by the PBP lens.

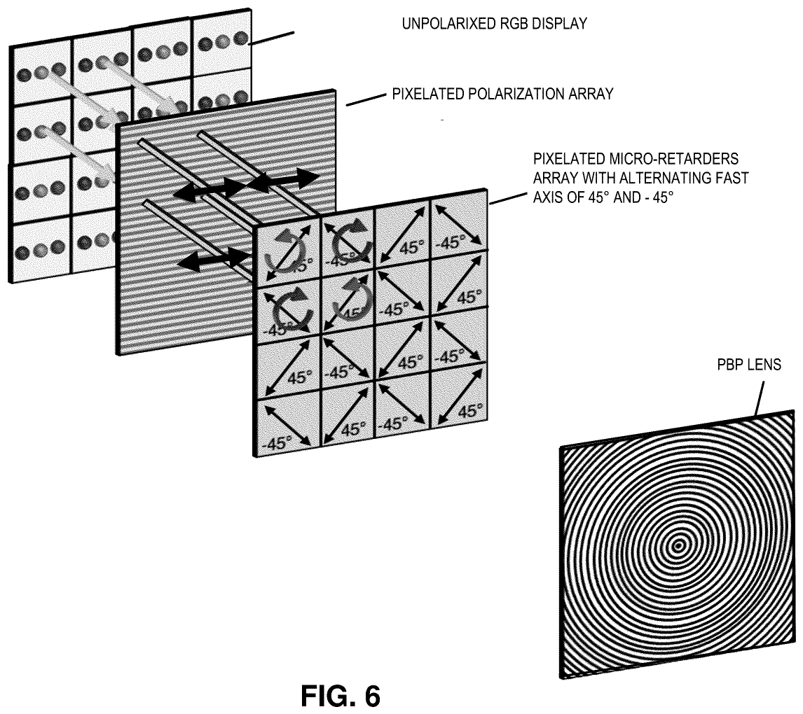

FIG. 6 illustrates an additional view of the multi-focal system of FIG. 5. In FIG. 6, the pixels of the pixelated retarder are configured to switch between 45 degrees and −45 degrees to selectively generate RHCP or LHCP display light to provide to the PBP lens.

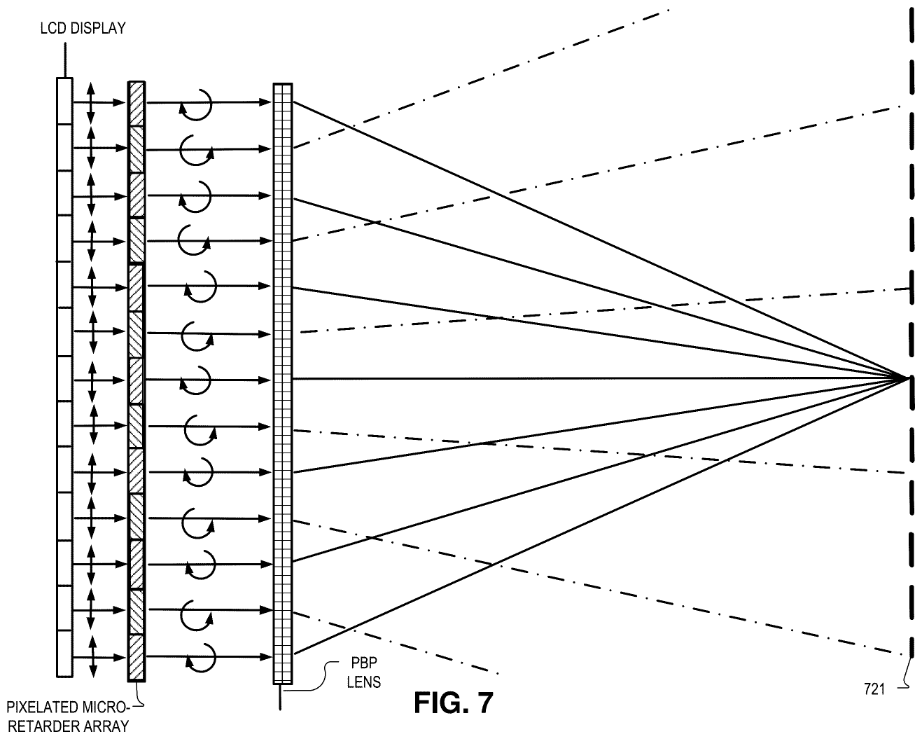

FIG. 7 illustrates that the linear polarizer of FIGS. 5 and 6 may be removed for a multi-focal system that has polarized display light generated by the display pixel array. For example, light from the LCD display is polarized such that a linear polarizer may be extraneous in order to focus the display light to focal length 721.

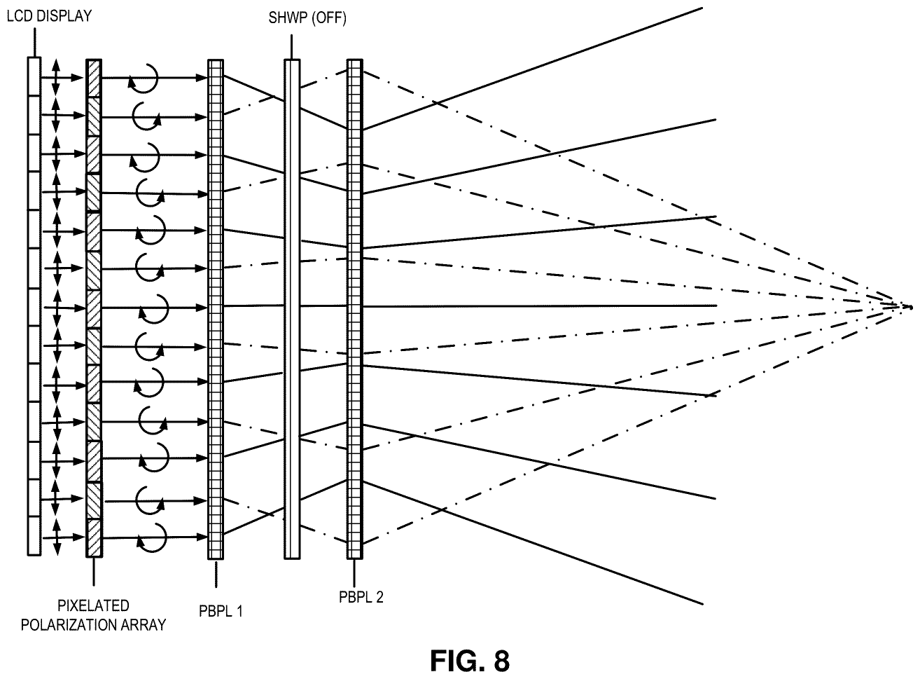

FIG. 8 illustrates that a switchable half waveplate and a second PBP lens can be added to the multi-focal system to provide four focal lengths, similar to the operation of the multi-focal system in FIGS. 4A-4B. However, the four focal lengths in FIG. 8 are selected by driving the pixels in the pixelated retarder array and driving the switchable waveplate, whereas the focal lengths of the multi-focal system of FIGS. 4A-4B are selected by driving different subsets of the display pixels and driving the switchable waveplate.

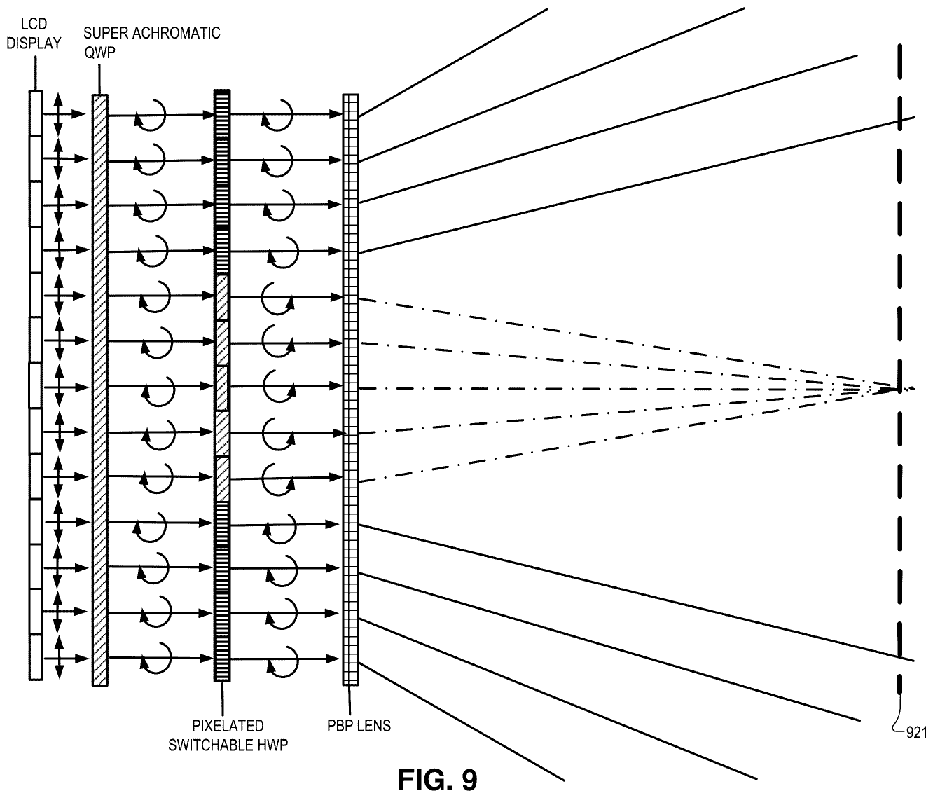

FIG. 9 illustrates a multi-focal system that includes a display pixel array, a pixelated switchable waveplate, and a PBP lens. In the illustration of FIG. 9, the display pixel array generates linearly polarized display light and a QWP generates RHCP display light from the linearly polarized display light incident on the QWP. The pixelated switchable waveplate has an array of switchable pixels configured to (1) generate a first polarization orientation (e.g. LHCP) of the display light while driven to a first retardance state (e.g. 180 degrees phase shift); and (2) generate a second polarization orientation (e.g. RHCP) of the display light while driven to a second retardance state (e.g. 0 degrees phase shift). In the illustration of FIG. 9, the middle switchable pixels are driven to the first retardance state to provide the PBP with LHCP to focus at focal length 921 and the outside switchable pixels are driven to the second retardance state to provide the PBP with RHCP to focus at a different (negative) focal length than focal length 921.

A second implementation of the disclosure includes Time-of-Flight (TOF) with Duty Cycle Modulation. In the context of eye-tracking, fringe patterns have been used to illuminate an eyebox region with a fringe pattern and then an image is captured of the fringe pattern to achieve three-dimensional (3D) sensing of an eye occupying the eyebox region. Image processing may be performed on the image of the fringe pattern to generate eye data that is used to determine a depth and/or position of the eye in the eyebox region, for example. A fringe pattern may be projected onto an eye by a projection system of a head mounted device (e.g. smartglasses or Augmented Reality, Mixed Reality, or Virtual Reality headset) and a camera of the head mounted device may capture the image of the fringe pattern for depth sensing analysis.

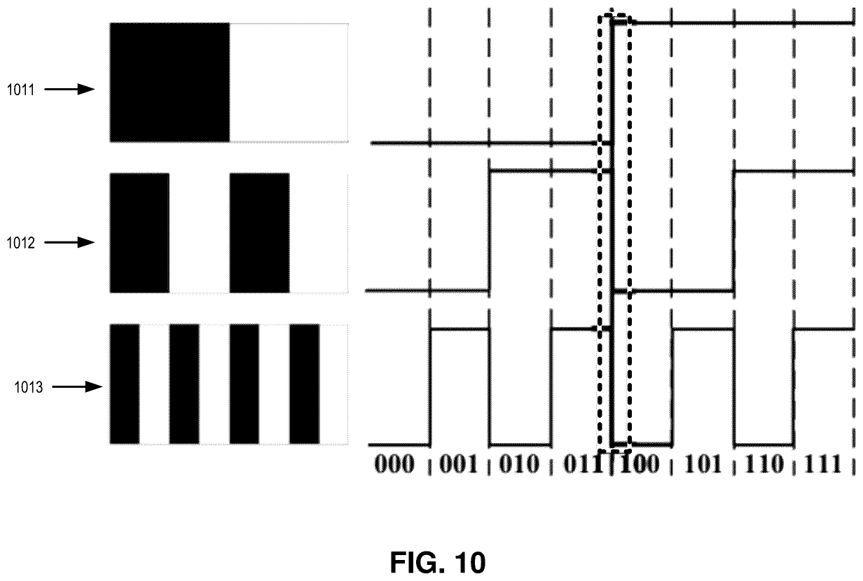

In fringe based structured light sensing, one of the key questions is how many different fringe patterns need to be illuminated onto the target. FIG. 10 shows a first fringe pattern 1011, a second fringe pattern 1012, and a third fringe pattern 1013. Sparser or lower bit stripes (e.g. first fringe pattern 1011) are applied onto the target to prevent ambiguity while denser or higher bit stripes (e.g. third fringe pattern 1013) are applied to the target to achieve higher resolution. However, illuminating too many different patterns onto the target slows down the image processing speed.

Indirect Time-of-Flight (iTOF) has also been used in eye-tracking contexts for measuring depth. However, iTOF may struggle with depth precision due to modulation speed. For example, it is difficult to achieve ˜100 micron resolution unless the modulation frequency is above 2 GHz.

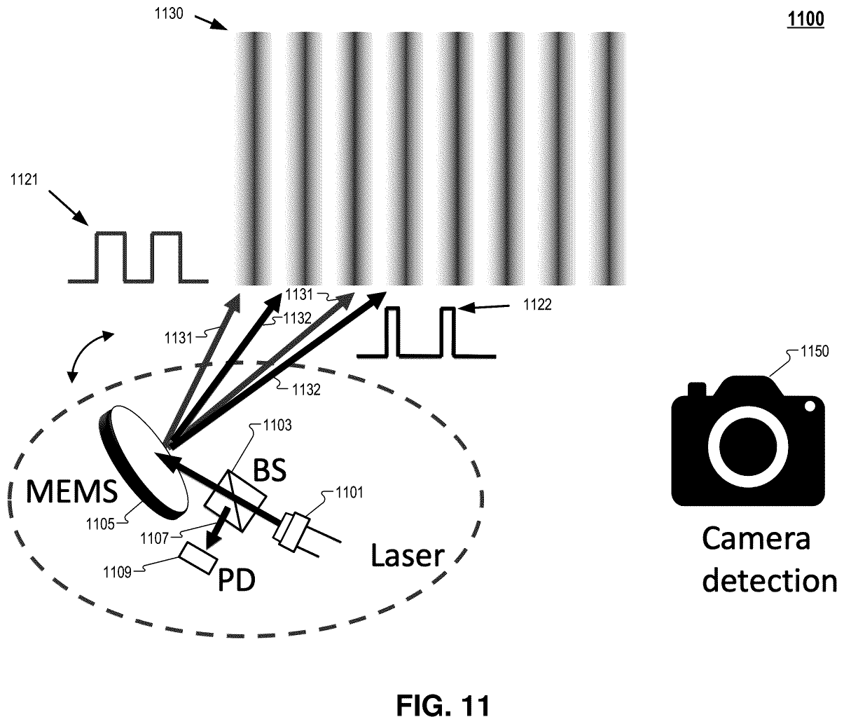

In implementations of the disclosure, pulse width modulation (PWM) based iTOF illumination is utilized for fringe pattern projection, as shown in FIG. 11. Brighter stripes (dark portion of pattern 1130) in fringe illumination pattern 1130 correspond to the larger duty cycle of laser signal 1121 while dimmer strips (bright portion of pattern 1130) correspond to the smaller duty cycle of laser signal 1122. The frequency of the PWM modulation of laser 1101 is kept the same and is the modulation frequency of the iTOF signal. In other words, laser signal 1121 and laser signal 1122 have the same modulation frequency, but different pulse widths. In some implementations, the modulation frequency of laser 1101 is below 200 kHz. In some implementations, the modulation frequency of laser 1101 is between 100 kHz and 200 kHz.

In FIG. 11, laser 1101 illuminates MEMS scanner 1105 with laser light. The laser light may be near-infrared light. The laser light propagates through beam splitter 1103 prior to being incident on MEMS scanner 1105. MEMS scanner 1105 scans the laser light to an eyebox region to generate fringe pattern 1130. The beams 1131 that generate the brighter fringes of pattern 1130 correspond with the wider pulse width in laser signal 1121 and the beams 1132 that generate the dimmer fringes of pattern 1130 correspond with the narrow pulse width of laser signal 1122. Laser 1101 is modulated by a laser signal with varying duty cycles (e.g. laser signal 1121, laser signal 1121) to generate the brighter and dimmer portions of fringe pattern 1130.

Camera 1150 captures an eye-tracking image of fringe pattern 1130 illuminating the eye and/or face of a user. The spatial frequency of fringe pattern(s) 1130 illuminating eye and/or face is extracted from the eye-tracking image using image processing techniques.

The phase of returning light that is reflected by the eye and/or face is also measured using iTOF. A portion of the laser light that illuminates the eye or face will be reflected/scattered back to MEMS scanner 1105 and become incident on beam splitter 1103. Beam Splitter 1103 directs at least a portion of the returning light to photodiode 1109 as iTOF light 1107. Photodiode 1109 generates a TOF signal (e.g. an electrical current) that may be mixed with a local oscillator signal to generate a phase signal. This phase signal indicates the TOF of the laser light and the TOF of the laser light can be used to determine the depth of the eye/face from the iTOF system.

Therefore, system 1100 generates (1) spatial frequency data from the eye-tracking image of camera 1150; and (2) TOF information from photodiode 1109 by measuring the phase of returning light.

In some implementations, the TOF information provides a rough depth of the eye/face for a given scan point of MEMS scanner 1105. For example, the TOF information may resolve depth at a particular scan point to about 1 cm. The rough depth from the TOF information can then be further refined using the spatial frequency data from the eye-tracking image captured by camera 1150. For example, the spatial frequency data combined with the TOF information may resolve the depth at the particular scan point to approximately 100 microns. By getting both the TOF information and the frequency data from the same fringe illumination projection, eye depth data accuracy can be increased while running at lower frequency (e.g. 200 kHz instead of 2 GHz) and displaying/projecting fewer different fringe illumination patterns to the eyebox region. Processing speed and power consumption may also decrease as a result since less image processing is required to analyze fewer fringe illumination patterns.

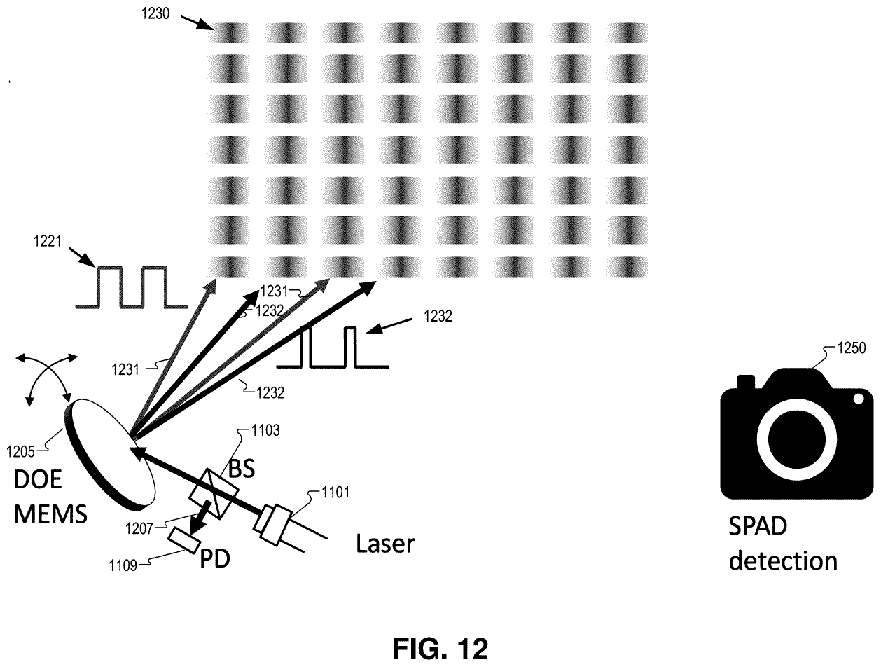

FIG. 12 illustrates that fringe pattern 1130 of FIG. 11 can be expanded to a 2D fringe pattern 1230 that includes a first spatial frequency and a second spatial frequency. The illustrated two-dimensional (2D) fringe pattern includes a first spatial frequency along an x-axis and a second spatial frequency along a y-axis of the 2D fringe pattern 1230. In the implementation of FIG. 12, MEMS scanner 1205 scans in two-dimensions to generate 2D fringe pattern 1230. MEMS scanner 1205 may include a diffractive optical element (DOE) on the face of the scanner to scan out the laser light emitted by laser 1101.

In FIG. 12, laser 1101 illuminates DOE MEMS scanner 1205 with laser light. The laser light may be near-infrared light. The laser light propagates through beam splitter 1103 prior to being incident on DOE MEMS scanner 1205. DOE MEMS scanner 1205 scans the laser light to an eyebox region to generate fringe pattern 1230. The beams 1231 that generate the brighter fringes of pattern 1230 correspond with the wider pulse width in laser signal 1221 and the beams 1232 that generate the dimmer fringes of pattern 1230 correspond with the narrow pulse width of laser signal 1222. Laser 1101 is modulated by a laser signal with varying duty cycles (e.g. laser signal 1221, laser signal 1232) to generate the brighter and dimmer portions of fringe pattern 1230.

FIG. 12 also illustrates that a single-photon avalanche diode (SPAD) camera 1250 may capture an eye-tracking image of fringe pattern 1230 illuminating the eye and/or face of a user. The spatial frequency of fringe pattern(s) 1230 illuminating eye and/or face is extracted from the eye-tracking image using image processing techniques.

In a third implementation of this disclosure includes Optical Vortex Arrays for Adaptive Dynamic Illumination. Structured illumination based three-dimensional (3D) sensing relies on illuminating the objects with known patterns of light. Signal processing algorithms are then used to compute the 3D profile of the object. In one group of implementations, stereo cameras can be used to correlate two images captured from different angles. If no distinct intensity-based features are present (for example white sclera in the eyeball) this becomes problematic. Alternatively, a stereo capture method can be enhanced by projecting structured light patterns that create the features that are needed for depth reconstruction. In another group of implementations, the object is illuminated with a known pattern and the image for the object is captured with a single camera. Multiple patterns can be used here and the reconstruction can be done using classical approaches such as phase shifting profilometry or with ML machine learning-based approaches. The key problem with these methods is that different objects can benefit from the use of different illumination patterns and the switching between these patterns typically require complex projection systems.

As a part of this disclosure, the Applicant introduces utilizing correlated vortex arrays to illuminate the object for profilometry purposes. Correlated vortex arrays can be generated using a static or dynamic phase mask in conjunction with an illumination source. The pattern has a high depth of field that is desirable for measuring objects such as an eye. Also, the patterns can be dynamically changed to adjust for different fitment of augmented reality (AR) and/or virtual reality (VR) device. Additionally, the area which is illuminated can be dynamically controlled for improving power efficiency. Dynamic pattern control can be achieved through the use of a single static phase mask and by modulating the coherence properties of the light source. Alternatively, a dynamic phase mask in conjunction with adjustable light source could be used. Finally, polarization modulation at the light source level can be employed for switching between two or more pre-set illumination patterns.

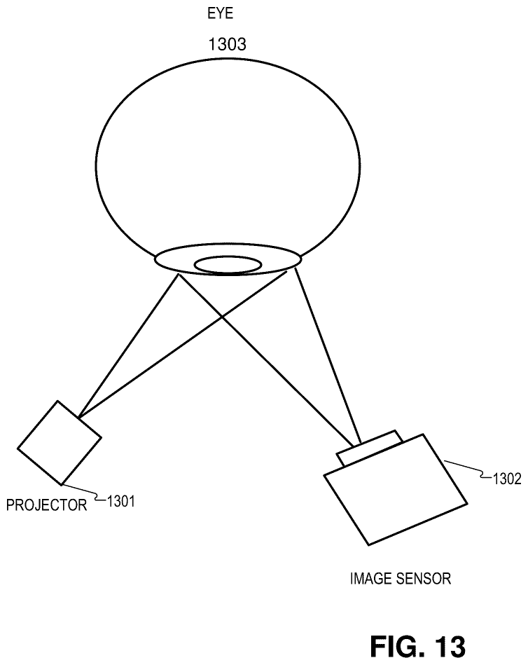

FIG. 13 illustrates an eye tracking system where projector 1301 projects a pattern including vortex arrays to eye 1303 and includes one or more image sensor(s) 1302 to capture the intensity distribution. The image sensor 1303 can be a camera or a point scanning source. The camera may be a widefield camera, or camera with individually addressable pixels, or multiple micro cameras. The vortex arrays projected in this disclosure may be far-field interference patterns modulated by changing the phase mask or changing the coherence length of the source.

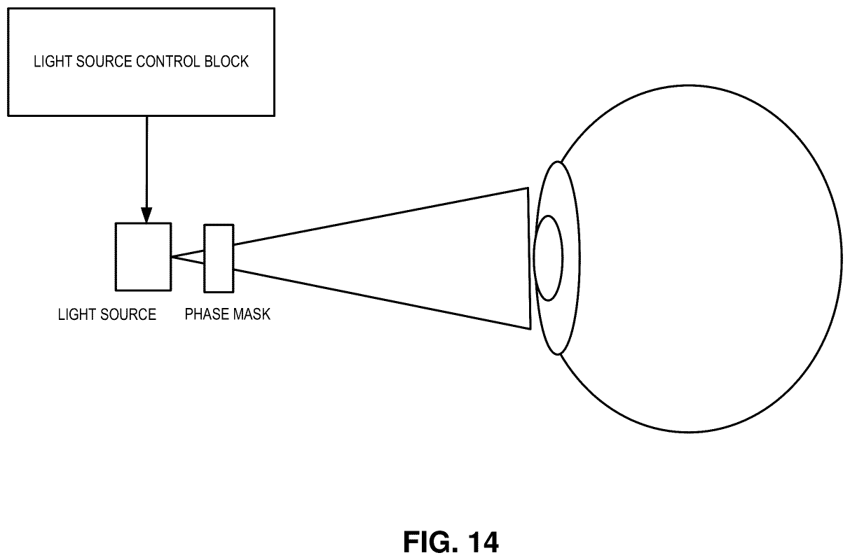

FIG. 14 illustrates an embodiment of the projector including a light source and a phase mask. The light source could be a vertical cavity surface emitting laser (VCSEL) or light emitting diode (LED) or superluminescent light emitting diode (SLED) or any other coherent or partially coherent source with low spatial coherence. The eye tracking is performed through either a free space interface or a waveguide. The light source control block is used to modulate the coherence of light through either spectral broadening or switching the light sources in a compound light source that includes multiple individual light sources with different coherence and/or polarization properties. The different coherence properties would result in different intensity distribution at the projection plane. The phase mask is fixed, however, it may be designed to produce different patterns depending on the polarization and or spectral properties of the light source. The phase mask may be designed to work either in transmission mode as shown in FIG. 14. or in a reflection mode (not illustrated). The phase mask may be either miniature and closely positioned to the sources shown in FIG. 14 or it could be integrated at the end of a waveguide for in-line illumination through AR and/or VR glasses. In another embodiment, the phase mask could work in reflection and it could be defined over a relatively large surface of the optical interface of AR and/or VR glasses.

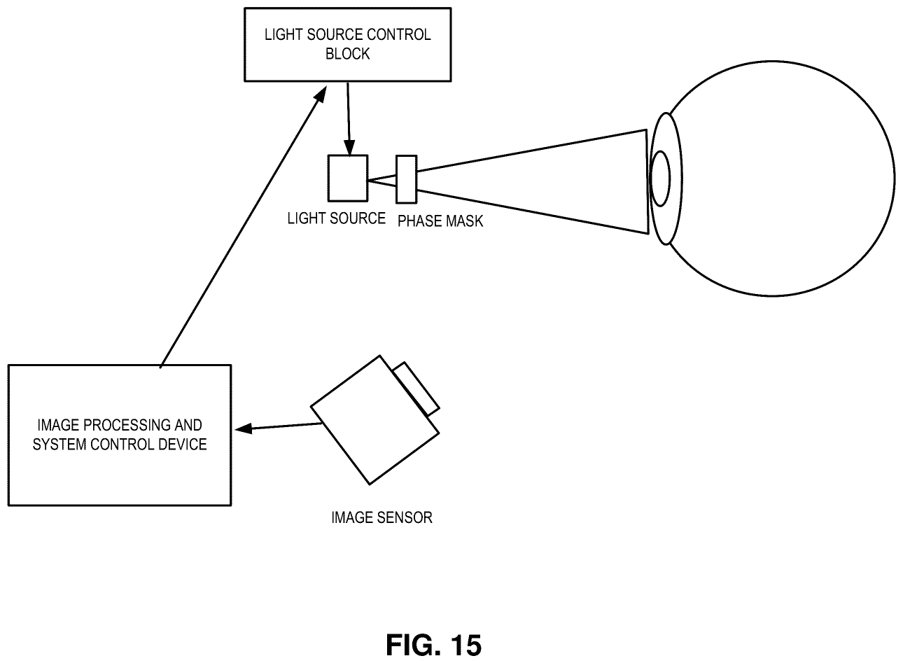

FIG. 15 illustrates an embodiment of the projector including a light source and a phase mask. The light source could be a vertical cavity surface emitting laser (VCSEL) or light emitting diode (LED) or superluminescent light emitting diode (SLED) or any other coherent or partially coherent source with low spatial coherence. FIG. 15 includes an image processing and system control device. The pattern is controlled to be wider or narrower based on the feedback from the image sensor. If the eye is located in the center of the pattern with which illuminates only central part is selected and the source power is reduced. If required for better tracking performance, the pattern is widened and the optical output from the source is increased.

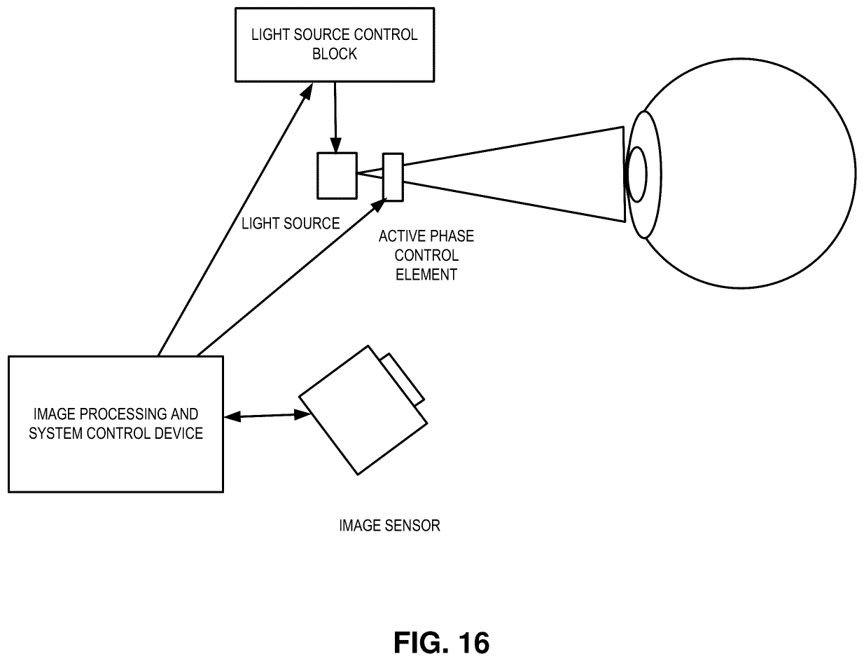

FIG. 16 illustrates an embodiment of the projector including a light source and an active phase control element such as a Spatial light modulator (in transmission), deformable mirror (in reflection), instead of the phase masks in FIGS. 14, and 15. The light source could be a vertical cavity surface emitting laser (VCSEL) or light emitting diode (LED) or superluminescent light emitting diode (SLED) or any other coherent or partially coherent source with low spatial coherence. Alternatively, the active phase control element could contain a passive phase mask and an axial distance adjustment mechanism. In this embodiment, the intensity distribution at the illumination plane is controlled either through the light source coherence properties, through the active phase control element, or through a combination of both control mechanisms.

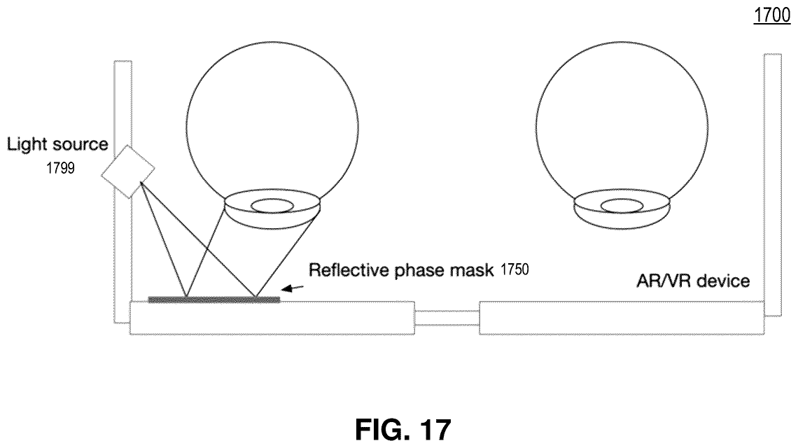

FIG. 17 illustrates a head mounted device 1700 including a reflective phase mask 1750 and light source 1799, in accordance with aspects of this disclosure. The light source 1799 illuminates the reflective phase mask 1750 that generates the optical vortex arrays directed to the eyebox area.

A fourth implementation of this disclosure includes non-line-of-sight retinal imaging. Retinal imaging is of great value for eye tracking contexts, for example. Traditional eye trackers usually use the eye surface information for eye tracking, such as information form cornea, iris, sclera, and pupil. However, the retina is the most direct tissue to receive light signals. With retina imaging, display(s) in VR and AR devices can achieve further miniaturization, lower power consumption, and higher quality. However, traditional retinal imaging usually assumes lines of sight, where the camera and lasers directly image the retina. However, due to eye rotation, the retina may be outside a camera's direct line of sight, leading to the system only working for a very constrained gaze range.

In this fourth implementation of the disclosure, non-line-of-sight technologies for retinal imaging is described. Time-of-flight (TOF) based non-line-of-sight (NLOS) imaging systems have recently demonstrated impressive results. TOF principles takes a light pulse to travel along a direct path. NLOS uses multi-bounce light paths to measure the visual appearance of a 3D shape.

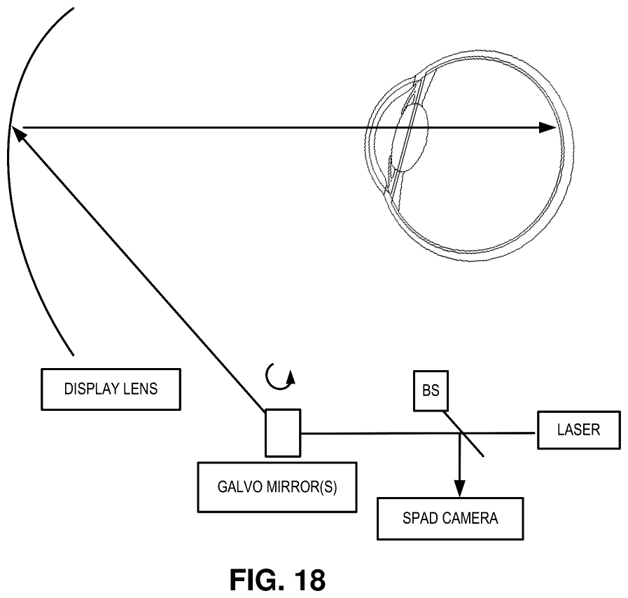

FIG. 18 illustrates a laser, a beam splitter (BS) that may be a Polarized Beam Splitter, a SPAD camera, Galvo mirror(s) and a display lens. The laser emits a narrowband infrared wavelength.

In the illumination optical path, the laser emits laser light that propagates through the beam splitter to illuminate the galvo mirror(s). The galvo mirrors are driven to direct the laser light to different points on the display lens that may be included in a head mounted device. At least a portion of that light reflects off the display lens and propagates through the pupil to illuminate the retina.

In the return optical path, at least a portion of the illumination light reflects/scatters off the retina as returning light. The returning light propagates back through the pupil and encounters the display lens. The display lens reflects at least a portion of the returning light back to the galvo mirror(s) which directs the light to the beam splitter. The beam splitter directs at least a portion of the light to the SPAD camera.

Thus, the display lens may be used as a scatter wall. By acquiring these timing measurements for different laser positions on the wall, the 3D geometry and appearance of the retina can be reconstructed. Additionally, as the eye rotates, the galvo mirror(s) can be driven to direct the laser light to different positions on the display lens to reflect through the pupil and onto the retina to be reflected/scattered back to the SPAD camera on the returning optical path. Thus, this implementation allows for imaging of the eye even for different eye rotations.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I2C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A multi-focal system comprising:
a display pixel array including a first display pixels generating first display light and a second display pixels generating second display light;
a pixelated polarization array having first pixels and second pixels, the first pixels aligned with the first display pixels to generate a first polarized light having a first polarization orientation, and the second pixels aligned with the second display pixels to generate a second polarized light having a second polarization orientation different from the first polarization orientation; and
a Pancharatnam-Berry phase (PBP) lens configured to:
focus the first polarized light having the first polarization orientation to a first focal length; and
focus the second polarized light having the second polarization orientation to a second focal length that is greater than the first focal length.

2. The multi-focal system of claim 1 further comprising:
a quarter wave plate disposed between the PBP lens and the pixelated polarization array.

3. The multi-focal system of claim 1, wherein the first polarization orientation is a first linear polarization orientation that is orthogonal to a second linear polarization orientation of the second polarization orientation.

4. The multi-focal system of claim 1, wherein the PBP lens is configured as a converging lens for the first polarization orientation to focus the first polarized light to the first focal length, and wherein the PBP lens is configured as a diverging lens for the second polarization orientation to focus the second polarized light to the second focal length.

5. The multi-focal system of claim 1, wherein the display pixel array includes an organic-light-emitting-diode (OLED) display pixel array.

6. The multi-focal system of claim 1 further comprising:
processing logic configured to drive the first display pixels during a first time period, and wherein the processing logic is configured to drive the second display pixels during a second time period subsequent to the second time period, the first time period being separated from the second time period.

7. A multi-focal system comprising:
a display pixel array including a first display pixels generating first display light and a second display pixels generating second display light;
a pixelated polarization array having first pixels and second pixels, the first pixels aligned with the first display pixels to generate a first polarized light having a first polarization orientation, and the second pixels aligned with the second display pixels to generate a second polarized light having a second polarization orientation different from the first polarization orientation;
a first Pancharatnam-Berry phase (PBP) lens;
a second Pancharatnam-Berry phase (PBP) lens; and
a switchable waveplate disposed between the first PBP lens and the second PBP lens.

8. The multi-focal system of claim 7 further comprising:
processing logic configured to:
drive the multi-focal system to a first focal length by driving the first display pixels to generate the first display light while driving the switchable waveplate to a first retardance state;
drive the multi-focal system to a second focal length by driving the first display pixels to generate the first display light while driving the switchable waveplate to a second retardance state;
drive the multi-focal system to a third focal length by driving the second display pixels to generate the second display light while driving the switchable waveplate to a first retardance state; and
drive the multi-focal system to a fourth focal length by driving the second display pixels to generate the second display light while driving the switchable waveplate to a second retardance state.

9. A multi-focal system comprising:
a display pixel array including a first display pixels generating first display light and a second display pixels generating second display light;
a pixelated retarder array having first retarders and second retarders, the first retarders aligned with the first display pixels to generate a first polarized light having a first polarization orientation, and the second retarders aligned with the second display pixels to generate a second polarized light having a second polarization orientation different from the first polarization orientation; and
a Pancharatnam-Berry phase (PBP) lens configured to:
focus the first polarized light having the first polarization orientation to a first focal length; and
focus the second polarized light having the second polarization orientation to a second focal length that is greater than the first focal length.

10. The multi-focal system of claim 9 further comprising:
a linear polarizer disposed between the display pixel array and the pixelated retarder array.

11. The multi-focal system of claim 9 further comprising:
a second PBP lens; and
a switchable waveplate disposed between the PBP lens and the second PBP lens.

12. (canceled)

13. (canceled)
